(19) United States
(12) Patent Application Publication
(10) Pub. No.: US 2007/0116213 A1
(43) Pub. Date: May 24, 2007

(54) Methods and apparatus to detect and block unwanted fax calls

(76) Inventors: Carol Shifrin Gruchala, Naperville, IL (US); Wayne Robert Heinmiller, Elgin, IL (US); Dianna Inara Tiliks, Palatine, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/250,713

(22) Filed: Oct. 13, 2005

(51) Int. Cl. H04M 11/00

(52) U.S. Cl. 379/100.01

(57) ABSTRACT

Methods and apparatus are disclosed to detect and block fax calls. An example method disclosed herein detects a fax call from a calling number; blocks the fax call if the calling number is associated with a caller to be blocked identified in a database and the fax call is sent to a subscriber; and attempts to identify a presence of a war-dialing technique.

### FIELD OF THE DISCLOSURE

This disclosure relates generally to facsimile communications (faxes), and, more particularly, to methods and apparatus to detect and block unwanted fax calls.

### BACKGROUND

Fax machines in businesses or personal residences typically require a shared or dedicated telephone line, ink toner, and paper stock for proper operation. The fax machine consumes all three of these resources during operation. That is, the fax machine occupies the telephone line and deposits ink toner on paper stock to receive and communicate fax information to a user.

Nuisance and unsolicited commercial faxes are those that the user, employee, or homeowner does not want to receive. Examples of such nuisance faxes include unwanted sales brochures and marketing surveys in which the unwanted fax transmissions tie-up the dedicated or shared telephone line and consume ink toner and paper stock. Individuals and organizations (hereinafter fax-marketers and/or callers to be blocked) that forward such nuisance faxes often employ a tactic known as “war-dialing” to discover and use fax machines connected to a dedicated telephone line as a method to push their sales and marketing information. War-dialing includes simultaneously calling numerically consecutive blocks of destination telephone numbers, typically from several originating telephone lines, with the objective of finding at least some fax machines at those numerically consecutive destination numbers. War dialing may include simultaneously calling a block of numbers, sequentially calling numerically consecutive numbers, and/or sequentially calling blocks of numbers. War-dialing is particularly successful for fax-marketers targeting mid to large size businesses that allocate a bank of numerically consecutive telephone numbers (lines) dedicated to fax machines in various locations throughout that business.

Although the fax-marketers do not know which, if any, of the dialed numbers will reach a functional fax machine, those numbers that answer with fax handshaking tones will establish a connection and receive the nuisance fax information. The nuisance fax information thus unnecessarily consumes ink toner, paper stock, and ties-up the telephone line of the receiving party during transmission. Additionally, such fax-marketing techniques present irritating fax-tones to people that answer a ringing telephone line with a telephone.

### BRIEF DESCRIPTION OF THE DRAWINGS

FIG. 1 is a schematic diagram illustrating an example fax-blocker constructed in accordance with the teachings of the invention and shown in an example send/receive environment.

FIG. 2(a) is a diagram illustrating an example war-dialing technique which may be immediately detected by the example fax-blocker of FIGS. 1 and 3.

FIG. 2(b) is a diagram illustrating an example war-dialing technique which may be determined through records analysis by the example fax-blocker of FIGS. 1 and 3.

FIG. 3 is a schematic diagram illustrating further details of the example fax-blocker of FIG. 1.

FIG. 4 illustrates an example data structure which may be created for each originating fax caller.

FIGS. 5(a)-5(b) are flow charts representative of example machine readable instructions which may be executed to implement the example fax blocker shown in FIG. 1 and FIG. 3.

FIG. 6 is a schematic illustration of an example computer which may execute the programs of FIGS. 5(a) and 5(b) to implement the fax-blocker of FIG. 1 and FIG. 3.

### DETAILED DESCRIPTION

Methods and apparatus to detect and block unwanted fax calls are disclosed. An example method includes detecting a fax call associated with a calling number, blocking the fax call if the calling number is associated with a caller to be blocked identified in a database, and attempting to identify a presence of a war-dialing technique. An example apparatus includes a pattern-trap to identify originating phone numbers exhibiting a calling pattern indicative of fax-marketing. The apparatus may include a fax-originator database to store identities of callers to be blocked, and a fax-originator detector in communication with the fax-originator database to determine if a fax call should be blocked.

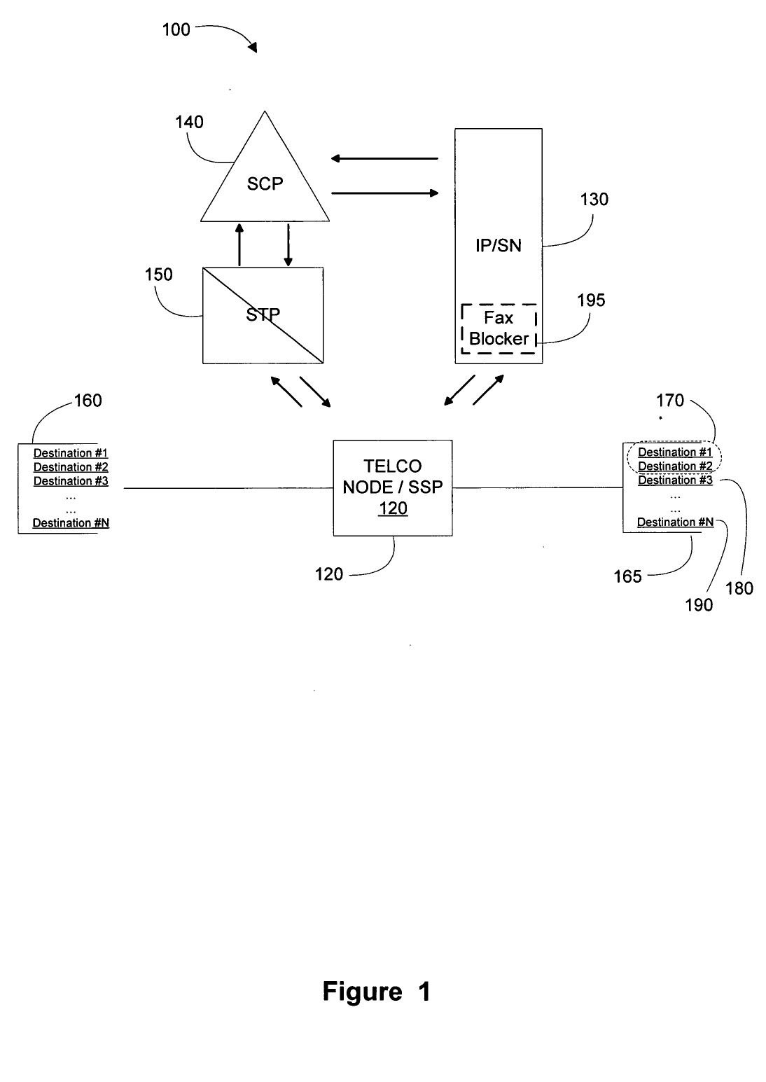

An example telecommunications network 100 is shown in FIG. 1. As mentioned above, a fax-marketer may generate a list of sequential telephone numbers to call when searching for fax machines. To this end, the fax-marketer gains access to any standard telecommunications network through a first telecommunications node (Telco Node) 120 and one or more telephone lines. The Telco Node 120 is also referred-to as a service switching point (SSP) or a signal switching point. Additionally, the Telco Node or SSP may be referred to as an end office (EO). Although in the following description the network 100 is an advanced intelligent network (AIN) operation in accordance with the Signaling System 7 (SS7) protocol, persons of ordinary skill in the art will appreciate that other types of telecommunication networks are also applicable.

Telecommunication companies may use an Intelligent Peripheral and/or Service Node (IP/SN) device or devices to manage the flow of communications between telephone/fax callers and receivers. IP/SN devices 130 may provide routing and/or control services in conjunction with the AIN 100. IP/SN devices 130 are flexible devices in that they may be programmed to perform specific tasks and functionality with any compatible network 100. IP/SN devices 130 are sometimes referred to as Compact Service Nodes (CSN), eMRS and RM devices, as is well known to those having ordinary skill in the art of telecommunication networks.

Telephone and/or fax calls made by a fax-marketer are routed to the Telco Node 230, which queries an AIN signal control point (SCP) 140 via a signal transfer point (STP) 150. The STP 150 is a packet switch that shuttles messages between the SSP 120 and the SCP 140. The SCP 140 is a remote database to, in part, supply translation and routing data for delivering advanced network services. The SCP 140 may provide, for example, instructions on how a call should be routed. Calls without routing instructions in the SCP 140 may further be screened through the IP/SN 130 for further instructions. Instructions from either the SCP 140 or the IP/SN 130 are routed back to the Telco Node 120 to accommodate the call, from which those calls branch-out to localized telecommunication devices, such as telephones and fax machines. As will be discussed in further detail below, a fax-blocker 195 of the IP/SN 130 provides, in part, real time call screening.

A list of numerically consecutive numbers 160 to dial is sometimes referred to as a war-dialing list. If a fax-marketer initiates a calling strategy with the list of numerically consecutive numbers 160, the telecommunications network 100 may accommodate that request by connecting the calling party (e.g., the fax-marketer) with the corresponding people or devices with which the called telephone number is associated 165 (e.g., a person answering a voice telephone, a private fax machine, one or more fax machines in a business, etc.). For example, the first two numerically consecutive numbers 170 dialed by the fax-marketer may correspond to a small business with two fax machines while the third number 180 may correspond to a single fax machine in the same small business, in another business, or in a person's home. Additionally, other numbers 190 dialed by the fax-marketer may correspond to a voice telephone number, resulting in annoying fax-tones presented to an ear of the called party.

In the illustrated example, a fax-blocker 195 is provided at the IP/SN 130 to detect fax calls, automatically identify fax marketers and/or their calling behavior, determine if a fax call originates from a caller to be blocked (e.g., a fax-marketer), and block fax call attempts by that caller if the called terminating number(s) are associated with a subscriber to the fax-blocking service. The caller to be blocked may include originating callers exhibiting war-dialing behavior, and/or a focused business having an objective to discover fax destination numbers. For ease of reference, the callers to be blocked and the fax-marketers will be referred to as “fax-marketers.” To this end, the illustrated example fax-blocker 195 maintains a database of known or suspected fax-marketers, fax-originators, and/or originating callers for the benefit of users that subscribe to a blocking service. In addition to, or in lieu of subscribers realizing a benefit from the blocking service, such blocking services may be provided to other customers and/or third parties. For example, the blocking services may be extended to potential customers as an incentive, and/or extended to existing customers as a promotion free of charge.

The fax-blocker database may grow with new numbers as the fax-blocker 195 identifies additional fax-marketers based on their calling behavior. Although fax-marketers may compile lists of known fax machines (e.g., from business cards, web sites, phone books, etc.), war-dialing techniques are primarily employed by the fax-marketers to determine fax machines on unadvertised and undisclosed destination numbers. A subscriber may use the database established by the fax-blocker 195 as-is, or alternately, may customize a personalized blocking list to work with the fax-blocker database based on their preferences.

An example scenario in which a subscriber may choose to personalize a blocking list is when a subscriber wants to maintain blocking functionality for most of the identified fax-marketers in the fax-blocker database, yet allow faxes from one or more specific entries within that database. For example, consider the situation when an originating caller is identified by the fax-blocker 195 as a potential fax-marketer due to the originating caller making simultaneous fax transmissions to numerically consecutive numbers or the originating caller making fax transmissions in a pattern consistent with fax-marketing. The behavior of this caller fits a “nuisance faxer” characterization and, thus, in the course of time the number exhibiting this behavior would be identified as a fax-marketer and their faxes would ordinarily be blocked for subscribers of the fax blocking service. However, if these originating calls are from one department of a business communicating inter-office memos to various other parts of that same business, the originating fax caller may be a legitimate fax caller for the subscriber (i.e., for the parts of the same business) and, thus, the subscriber would like to personalize the blocking list to permit fax calls from this caller.

Although the example fax-blocker 195 is shown located at an IP/SN 130, persons of ordinary skill in the art will readily appreciate that one or more fax-blocker(s) 195 may be located at any other desired location(s) in the network 100. For example, the fax-blocker 195 may be associated with the IP/SN 130, associated with a signal control point (SCP), and/or associated with a feature/media server. Additionally or alternatively, the fax-blocker 195 may be integrated into an existing structure in the network (e.g., an IP/SN, an SCP, an STP, etc.), may be coupled to an existing structure in the network (e.g., an IP/SN, an SCP, an STP, etc.), and/or may be a stand alone unit. If the IP/SN 130 provides fax-tone detection services, the IP/SN 130 may automatically invoke the fax-blocker 195 only when needed (i.e., upon detection of a fax call), thereby conserving processing resources of the fax-blocker 195. Alternatively, the fax-blocker 195 may employ its own fax-tone detection services, as will be discussed later.

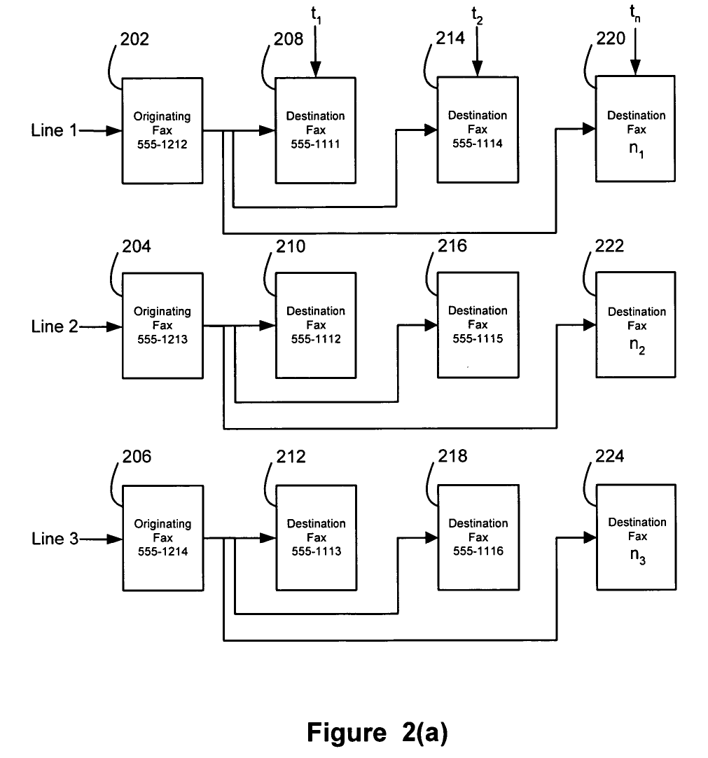

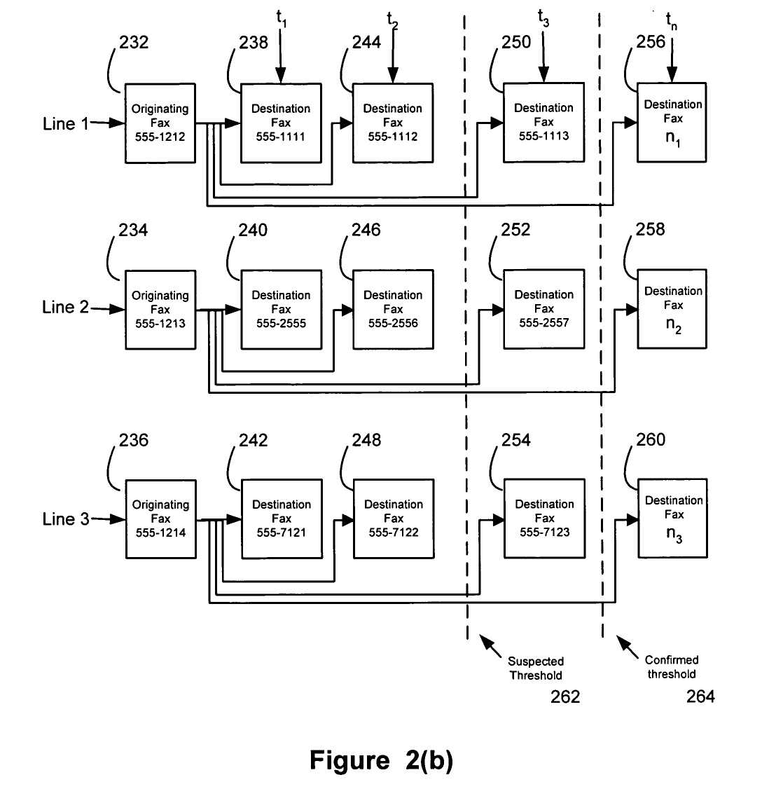

FIGS. 2(a) and 2(b) graphically illustrate various techniques that fax-marketers may employ when searching for available fax machines (war-dialing). Generally speaking, FIG. 2(a) illustrates a war-dialing technique that the fax-blocker 195 may immediately detect, whereas FIG. 2(b) illustrates a war dialing technique that may be detected after post-fax transmission analysis, as will be discussed later.

Referring first to FIG. 2(a), some fax-marketers may originate their war dialing techniques by using several originating telephone/fax lines, such as line 1 (202), line 2 (204) and line 3 (206). Each of these lines may be a standard telephone line having a fax machine, or similar fax transmission device connected thereto. FIG. 2(a) further illustrates line 1 having an originating number of 555-1212, line 2 having an originating number of 555-1213, and line 3 having an originating number of 555-1214. While a numerically consecutive block of telephone lines is typically assigned by a telephone company to a residence or business, a fax-marketer may also employ several lines having non-consecutive and/or arbitrary originating numbers. Although the above example illustrates a fax-marketer using a plurality of originating lines, persons of ordinary skill in the art will appreciate that a fax-marketer may employ devices that can simultaneously place numerous calls from the same originating telephone line. Such devices may effectively hide the caller identification (caller-ID), or replace such caller-ID with a number unassociated with the actual originating telephone line. Each of lines 1, 2, and 3 may, at a time “t₁,” call a numerically consecutive block of destination numbers. In particular, at time “t₁” line 1 calls destination number 555-1111 (208), line 2 calls destination number 555-1112 (210), and line 3 calls destination number 555-1113 (212). If any of the destination numbers happen to be a fax machine/device, the fax-marketer proceeds to transmit the unsolicited fax information. The fax-marketer may repeat this process at time “t₂” where a new group of numerically consecutive destination numbers is called to search for fax machines/devices. For example, at time “t₂” line 1 calls destination number 555-1114 (214), line 2 calls destination number 555-1115 (216), and line 3 calls destination number 555-1116 (218). Similarly, the fax-marketer may repeat this process at time “tₙ” in a similar manner with additional numerically consecutive destination numbers “n₁,” 220 n₂,” 222 and “n₃” 224. In another example, each of lines 1, 2, and 3 may, at time “t₁” call a numerically consecutive block of destination numbers, as described earlier. However, if only line 2 happens to establish a connection with a fax machine, (e.g., destination number 555-1112 (210)) and the destination numbers dialed by lines 1 and 3 are inoperative or not associated with a fax machine, then lines 1 and 3 may immediately proceed call destination numbers 555-1114 (214) and 555-1116 (218), respectively. In other words, lines 1 and 3 continue to hunt for additional fax machines while line 2 finishes sending fax-marketing information to the destination number it called at time “t₁.” The fax-marketer, thus, “staggers” such war dialing behavior so that destination numbers not associated with a fax machine do not sit dormant while waiting for another destination line to complete receipt of the nuisance fax information.

When a numerically consecutive pattern (i.e., consecutive originating numbers called substantially in parallel, but not, for example, to the possible staggering noted above) is detected at any particular time period (e.g., “t₁,” “t₂,” through “tₙ,”), the fax-blocker 195 may assume that the originating numbers are all associated with each other for the purpose of war dialing. Such an assumption allows the fax-blocker 195 to identify those originating numbers as fax-marketers in a single time period (i.e., immediately). A user of the fax-blocker 195 may find such an assumption reasonable given the remote possibility that unrelated originating numbers (e.g., originating numbers not owned or operated by single entity for the purpose of unsolicited fax solicitation) substantially simultaneously dial a numerically consecutive group of destination numbers. Alternatively, or additionally, the fax-blocker 195 may search one or more databases of the telecommunications network 100 to determine if such originating numbers are associated with a common entity.

FIG. 2(b) illustrates an alternate fax-marketing technique employed by a fax-marketer who may be aware of pattern detection techniques employed to thwart their nuisance marketing efforts. Similar to FIG. 2(a), FIG. 2(b) illustrates a fax-marketer with several originating fax lines, such as line 1 (232) having an originating number of 555-1212, line 2 (234) having an originating number of 555-1213, and line 3 (236) having an originating number of 555-1214. Each of these originating lines may be either independently owned/operated, or owned by a single fax-marketer to collaboratively hunt for a greater number of fax machines at destination numbers in a shorter period of time. At time “t₁,” destination number 555-1111 (238), destination number 555-2555 (240), and destination number 555-7121 (242) may be simultaneously called by the fax-marketer, or such calls may be made by fax-marketers unrelated to one another. Because the called numbers at time “t₁ ” are not numerically consecutive, the destination numbers do not immediately appear to exhibit a calling pattern at that time. As such, detection of a fax-marketer is accomplished through an analysis over a time period. For example, at time “t₂,” the fax-marketer calls each one of destination number 555-1112 (244) with originating line 1 (232), destination number 555-2556 (246) with originating line 2 (234), and destination number 555-7122 (248) with originating line 3 (236). An analysis of destination numbers between times “t₁” and “t₂” now reveals an emerging pattern of a numerically consecutive calling behavior for each of originating lines 1, 2, and 3. The fax-blocker 195 may deem each of the originating lines as potential fax-marketers when a suspected threshold 262 (in this example, two) of numerically consecutive calls is observed. Employing the suspected threshold 262 accommodates for circumstances in which a caller accidentally misdials a number by one digit. Rather than immediately add that originating caller's number to the fax-blocker database in light of an innocent mistake, the originating number is merely recorded/flagged as “suspected.” However, as shown at time “t₃,” each of originating lines 1, 2, and 3 respectively place calls to destination numbers 555-1113 (250), 555-2557 (252), and 555-7123 (254). As each of these three destination numbers is numerically consecutive from the previous call placed by the corresponding originating number at time “t₂,” the fax-blocker 195 flags each of these originating numbers as fax-marketers because a confirmed threshold 264 (e.g., three numerically consecutive calls) has been exceeded. Consequently, those fax-marketer numbers are added to the fax-blocker database. In the event any of the fax-marketers, whether they are related or not, attempts to call destination numbers “n₁,” 256 “n₂,” 258 or “n₃” 260 at time “tₙ” or thereafter, the fax-blocker 195 will block the fax call if the customer associated with destination number “n₁,” “n₂,” or “n₃” is a subscriber to the fax-blocking service.

Although the above example illustrates a suspected threshold 262 set at two numerically consecutive calls, and the confirmed threshold 264 set at three numerically consecutive calls by an originating line, persons of ordinary skill in the art will appreciate that such thresholds may be set at any desired number of calls. Further, while the above example illustrates the confirmed threshold 264 placed at a time interval immediately after the time interval associated with the suspected threshold 262, persons of ordinary skill in the art will appreciate that the confirmed threshold 264 could be placed several time intervals away from the suspected threshold 262. For example, the confirmed threshold 264 may alternatively be set such that if the suspected fax-marketer associated with originating line 1 (232) places an additional fax call to the destination number 555-1113 (250) at any time within a predetermined time period (e.g., 2 hours, 2 days, 2 weeks, etc.), originating line 1 (232) will be added to the fax-blocker database for future blocking for at least a predetermined time period.

Although FIGS. 2(a) (immediate war-dialing detection) and 2(b) (war-dialing detection following post-fax analysis) illustrate two possible war-dialing techniques that a fax-marketer may employ and that may be detected by the fax-blocker 195, this list is not exhaustive and the fax-blocker 195 may be structured to identify and block other techniques and/or behaviors characteristic of fax-marketing.

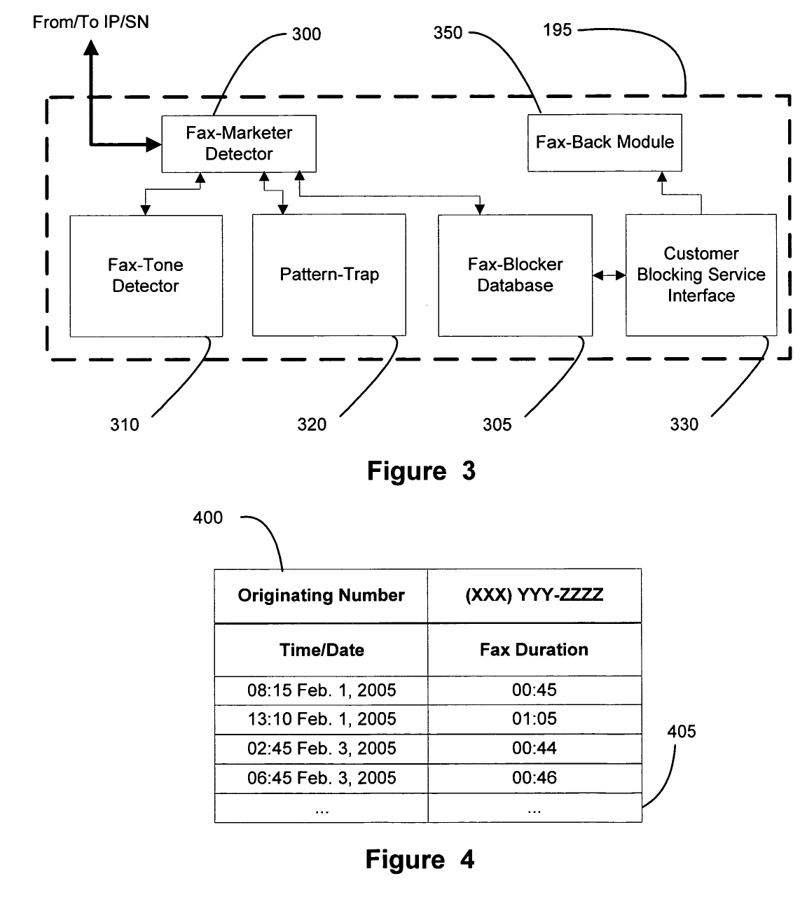

FIG. 3 is a more detailed schematic illustration of the example fax-blocker 195 of FIG. 1. In the example of FIG. 3, the fax-blocker 195 cooperates with an IP/SN 130. Thus, when the IP/SN 130 receives a message to assist in routing a call, it delivers the originating number and the destination number for that call to the fax-blocker 195 to determine if the call should be blocked. In order to identify fax calls, the fax-blocker 195 of the example of FIG. 3 includes a fax-tone detector 310. The fax-tone detector 310 monitors signals on a monitored telephone line or on a plurality of monitored telephone lines to determine which, if any, of the calls being handled by those line(s) are fax calls. Fax calls can be detected by, for example, identifying the presence of fax tones used in the handshaking process of facsimile protocols to establish a fax transmission. Although the fax-blocker 195 example of FIG. 3 includes a fax-tone detector 310, persons of ordinary skill in the art will appreciate that the fax-blocker 195 may, alternatively, employ the services of the IP/SN 130 to detect fax-tones. When calls including fax-tones are detected by the IP/SN 130, such calls may be forwarded to the fax-blocker 195 for further analysis. Methods and apparatus of detecting fax tones on a monitored phone line are well known and will, thus, not be discussed in further detail herein.

For the purpose of blocking faxes from known fax-marketers to subscribers of the fax blocking service, the example fax-blocker 195 of FIG. 3 is provided with a fax-marketer detector 300 and a fax-blocker database 305. The fax-blocker database 305 identifies the phone numbers of subscribers to the fax-blocking service and the phone numbers of known fax-marketers. Thus, when the fax-marketer detector 300 receives notification from the IP/SN 130 that a call is being placed, and this call is identified as a fax call, the fax-marketer detector 300 first addresses the fax-blocker database 305 to determine whether the called party is a subscriber to the fax-blocking service. If not, the fax-blocker 195 will not block the call. One of ordinary skill in the art will appreciate that in lieu of, or in addition to a fax-blocker database 305, an SCP may be employed to store subscriber numbers and known fax-marketers.

If, however, the called party is a subscriber, the fax-marketer detector 300 again accesses the fax-blocker database 305 to determine if the calling party is a known fax-marketer. If the called party is a subscriber and the call is originating from a fax-marketer identified in the fax-blocker database 305, the fax call will be blocked (unless expressly permitted through a subscriber override as explained below).

If, on the other hand, the fax-marketer detector 300 determines that the fax call is originating from a party that is not identified in the fax-blocker database 305, the call will be analyzed to detect war-dialing techniques irrespective of whether or not the called party is a subscriber. This default analysis allows the fax-blocker database 305 to continuously improve and update for the benefit of subscribers. Newly identified calling numbers exhibiting war-dialing techniques are added to the database 305 so their fax calls will be blocked for subscribers, but passed-through to non-subscribers.

Thus, if a fax call is not blocked because the calling party is not identified in the fax-blocker database 305 as a fax-marketer, the fax-blocker 195 will use the information associated with the call to attempt to determine whether the calling party should be classified as a fax-marketer. Only fax calls are used for this determination. Thus, the fax-tone detector 310 screens the call to determine if it is a fax and/or the IP/SN 130 only invokes the fax-blocker 195 when it detects a fax call. If the call is not a fax, the fax-blocker 195 ignores the call (or the fax-blocker 195 is never notified of the call if the IP/SN 130 performs the screening operation). If the call is a fax from a caller not already identified as a fax-marketer, the fax-detector 300 activates a pattern-trap 320. Similarly, improving the robustness of the fax-blocker database 305 without regard to subscriber status may proceed in alternate methods. For example, a bank of “decoy” fax machines may be employed to “trap” fax-dialers that are searching for fax machines, as will be discussed in further detail below.

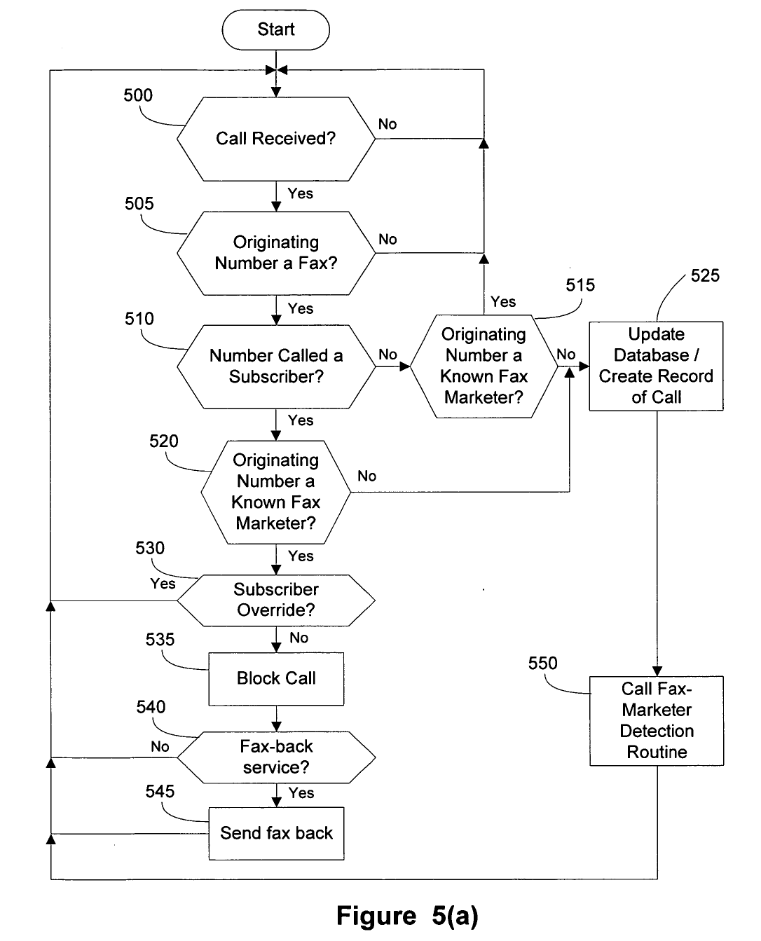

The pattern-trap 320 generates records reflecting fax calls from each originating number that is not already identified in the fax-blocker database 305 as a fax-marketer. Prior to characterizing a fax caller as a fax-marketer, assuming that war dialing techniques, such as those illustrated in FIG. 2(a), are not immediately detected, the dates, times, and duration of each fax call from the fax caller are recorded in a record 400, such as the record shown in FIG. 4 in an attempt to detect war-dialing techniques similar to those illustrated in FIG. 2(b). These records are stored in a database such as the fax-blocker database 305. As will be discussed later, records may be referred-to by the fax-blocker 195 to determine whether fax callers exceed various calling thresholds (which may or may not be subscriber defined). As fax callers make additional calls to a subscriber, row entries 405 are appended to the record 400 to reflect the fax call frequency (e.g., number of calls per unit of time) of the caller and the duration of the fax calls from that fax caller. Briefly returning to FIG. 2(b), upon an originating fax call at time “t₁” by line 1 (232), a record 400 may be created with a data row indicating when the fax was attempted, and a fax duration. Subsequently, at time “t₂” an additional row may be appended to the record 400 when line 1 (232) makes another fax transmission to destination fax 555-1112 (244).

The pattern-trap 320 of the illustrated example analyzes fax records 400 associated with an originating number in order to determine if the calling behavior reflects that of a fax-marketer. This analysis may be performed as the call is being made (“on the fly”). Additionally, or alternatively, the pattern-trap 320 may periodically analyze the fax records 400 to determine if the recorded calling behavior shown in the records reflects that of a fax-marketer. When the pattern-trap 320 detects a fax-marketer pattern, it saves the originating number(s) to the fax-blocking database 305. Calls by originating numbers already identified as a fax-marketer in the fax-blocker database 305 do not need to be recorded or analyzed to conserve fax-blocker 195 storage and processing resources. The fax records 400 may also track whether detected patterns indicative of war dialing occur within, for example, a corporation or originate outside the corporation. For example, a corporation may wish to distribute an important memo, but not know destination numbers for all the fax machines within the company. The company may then employ dialing techniques indicative of war-dialing. As such, an “allow list” may include originating numbers that are authorized to employ dialing techniques indicative of war-dialing. The originating fax caller may then, for example, fax a corporate bulletin to every fax machine within the corporation.

A fax-marketer may attempt to elude pattern detection by dialing non-sequential destination numbers. For instance, the fax-marketer may dial numbers separated by 2 digits, or by any other integer. Alternatively, the fax-marketer may re-arrange the sequence of war-dialing numbers in any other pattern. The pattern-trap 320 may be adapted to detect any known dialing patterns.

Destination numbers that are not allocated to a client typically greet a calling party with a recorded message indicating that the number called is no longer in service. As such, the fax-blocker 195 may also employ a bank of “decoy” fax-capable devices in an effort to further populate the fax-blocking database 305. The bank of decoy fax-capable devices may include disparate numbers of a telephone network that have never been assigned to a homeowner/business and/or disparate numbers that were previously used, but are no longer in service. Additionally, or alternatively, the bank of decoy fax-capable devices may include one or more groups of numerically consecutive numbers.

Fax-marketers that transmit to the decoy fax devices are unaware of whether or not the destination number reaches a homeowner or business. As such, the use of the decoy devices allows the fax-blocking database 305 to grow with originating numbers of fax-marketers, thereby improving the prevention of nuisance faxes for subscribers of the fax-blocker 195 services. Furthermore, the decoy devices may be configured to transmit at a low baud rate in an effort to consume the fax-marketer's resources for as long as possible. Because the fax-marketer cannot distinguish between the decoy fax-capable device and a fax machine at a home or business, such low baud rate settings result in slowing-down the rate at which fax-marketers may discover new fax destination numbers.

In order to permit subscribers to receive faxes from fax-marketer numbers stored in the database 305, the fax-blocker 195 is provided a customer blocking service interface 330. The customer blocking service may include a user-interface, including, but not limited to, a web-based interface that, upon identification of the subscriber's authentication credentials, permits that user to create, delete, and modify customized settings. Similar creation, deletion, and modification of the settings may also occur through an automated telephone interface. The subscriber may choose to accept a default blocking status (preferably initiated upon the setting up of the fax-blocking service) in which all numbers within the fax-blocker database 305 are blocked by the fax-blocker 195. Alternatively, the subscriber may create a personalized list or a set of rules that may allow certain numbers from the fax-blocker database 305 to complete fax transmissions to the subscriber that created the rule (but to no others). For example, if a small or large business routinely sends inter-departmental memos via fax, then the pattern-trap 320 may identify this behavior as a potential fax-marketer and add the originating fax number to the fax-blocker database 305. Although the originating number is, in fact, dialing numerically consecutive fax numbers simultaneously, the subscriber deems such activity useful rather than a nuisance. Thus, the subscriber can establish a rule permitting the “fax-marketer” in question to fax to any and all destination numbers associated with the subscriber.

Alternate example implementations of the fax-blocker 195 may employ the fax-marketer detector 300 to automatically identify that both the originating fax calling number and the numerically consecutive destination fax numbers are owned or operated by the same entity (e.g., business) and, thus, avoid the necessity of adding such originating fax calling numbers to the fax-blocker database 305. Additional subscriber defined rules may include, but are not limited to, allowing a predetermined threshold of fax attempts per unit of time. For example, a subscriber may enjoy receiving some promotional sales information from a fax-marketer. If, however, the fax-marketer sends too many faxes, then the fax-marketer detector 300 may be programmed to block all subsequent fax transmissions for a period of time (e.g., to block all but a predetermined number of faxes per day).

The subscriber may also configure the fax-blocker 195 to transmit a personalized fax-back message to fax-marketers. The customer blocking service interface 330 may further allow the subscriber to create a personalized message in an attempt to dissuade the fax-marketers from sending additional faxes. Thereafter, upon the fax-blocker 195 identifying a new fax-marketer, the customer blocking service interface 330 may forward the subscriber's fax-back message to a fax-back module 350 along with the fax-marketer phone number stored in the fax-blocker database 305. The fax-back module 350 may secure a telephone line, place a fax call to the fax-marketer, and transmit the fax-back message to that fax-marketer.

Although the above example enables user personalization of the fax-back message, persons of ordinary skill in the art will appreciate that non-personalized messages could also be appropriate. Further, although not discussed above, the subscriber would likely be expected to pay a monthly subscription fee for the fax-blocking service and an additional fee for the fax-back message service.

In addition to, or in lieu of the example fax-back message, the subscriber may configure the fax-blocker 195 with an announcement service to play an announcement to the originating caller. For example, after the originating caller's fax transmission attempt is blocked, the caller may manually call the destination number to determine if the destination fax number is working (e.g., to listen for fax-tones). Such a caller would be presented with a canned or personalized announcement, such as “Your call is blocked by the Fax Blocker. Please contact the party you wish to fax.”

Subscribers may add any numbers to their personalized list of faxes to block, even numbers that may not be present in the fax-blocker database 305. Creation and modification of the subscriber's personalized list may also occur via the customer blocking service interface 330 in the aforementioned web interface. Such a web interface may include data entry fields for one or more telephone numbers, fax numbers, and a personalized list display screen. Additionally, the web interface may include various function commands to add new numbers, edit existing numbers, and delete numbers from the personalized list. Despite subscriber flexibility in customizing the personalized list to augment the fax-blocker database 305, use of such a feature is optional and the example fax-blocker 195 preferably continuously and automatically updates the fax-blocker database 305 with new fax-marketer numbers without subscriber intervention.

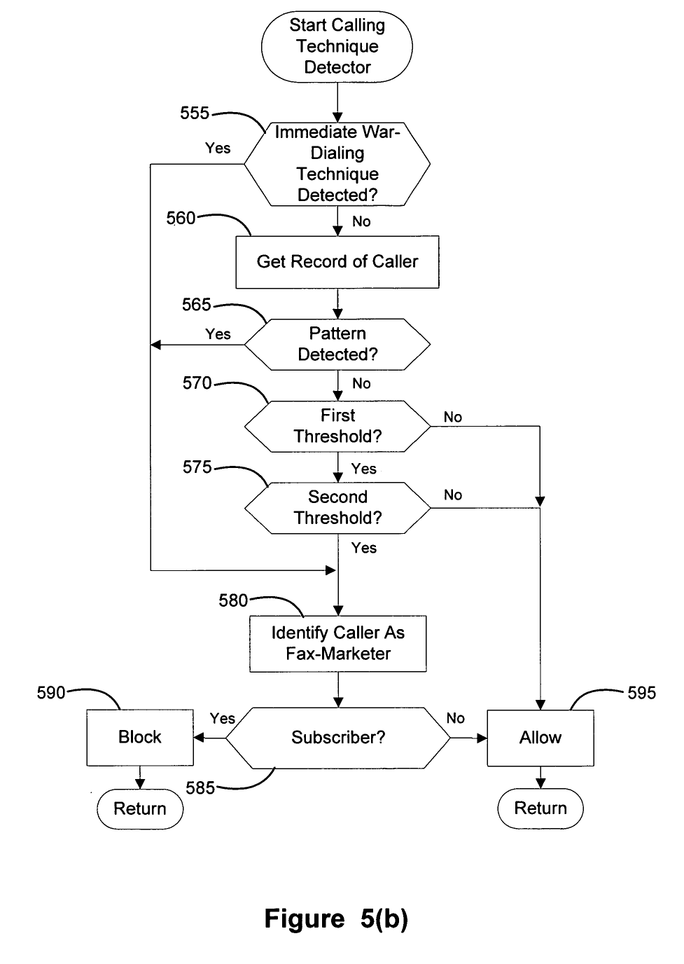

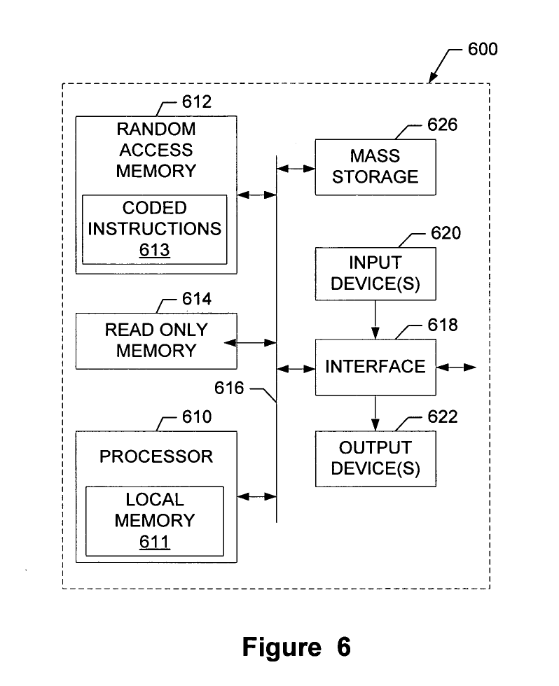

A flowchart representative of example machine readable instructions for implementing the fax blocker 195 of FIGS. 1 and 3 is shown in FIGS. 5(a) and 5(b). In this example, the machine readable instructions comprise a program for execution by: (a) a processor such as the processor 610 shown in the example computer 600 discussed below in connection with FIG. 6, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 610, but persons of ordinary skill in the art will readily appreciate that the entire program and/or parts thereof could alternatively be executed by a device other than the processor 610 and/or embodied in firmware or dedicated hardware in a well known manner (e.g., it may be implemented by an application specific integrated circuit (ASIC), a programmable logic device (PLD), a field programmable logic device (FPLD), discrete logic, etc.). For example, any or all of the fax-blocker 195, the fax-marketer detector 300, the fax-tone detector 310, the pattern-trap 320, the fax-blocker database 305, the customer blocking service interface 330, and/or the fax-back module 350 could be implemented by software, hardware, and/or firmware. Also, some or all of the machine readable instructions represented by the flowchart of FIGS. 5(a) and 5(b) may be implemented manually. Further, although the example program is described with reference to the flowchart illustrated in FIGS. 5(a) and 5(b), persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The program of FIG. 5(a) begins at block 500 where the fax-blocker 195 monitors the network 100 for calls by, for example, awaiting a message from the IP/SN 130. If no calls are received at block 500, the program loops at predetermined intervals until a call is received. When a call is received at block 500, the fax-marketer detector 300 receives a message from the IP/SN 130 identifying the originating number and the called number. The fax-tone detector 310 then determines if the originating call is a facsimile at block 505. If not a fax call (block 505), the fax-blocker 300 ignores the received call and returns a message to the IP/SN 130 to complete the call as normal. Control then returns to block 500, where the fax-marketer detector 300 continues to monitor for fax calls. As described earlier, the IP/SN 130 may, alternatively, monitor originating calls for fax tones and invoke the fax-blocker 195 only when necessary. In such an approach, block 505 may be eliminated.

If the fax-tone detector 310 determines that the originating number is a fax transmission (block 505), the fax-marketer detector 300 verifies if the number being called (destination number) is a subscriber of the fax blocking service (block 510). If not, the fax-marketer detector 300 still compares the originating number against entries in the fax-blocker database 305 (block 515). If the originating number has a match in the fax-blocker database 305, no further analysis is required and the fax-marketer detector 300, thus, returns a message to the IP/SN 130 to complete the fax call. Control then returns to block 500 to monitor for additional calls. On the other hand, if the originating number is not a known fax-marketer (block 515), control advances to block 525. Block 525 is discussed further below.

Returning, for purposes of discussion, to block 510, if the called party is a subscriber, the fax-marketer detector 300 compares the originating number against entries in the fax-blocker database 305 (block 520). Similar to block 515, if there is no match for the originating number in the fax-blocker database 305, control advances to block 525, discussed later. Alternatively, if there is a match for the originating number in the fax-blocker database 305, that number may not have been categorized as a fax-marketer because, for example, various calling thresholds have not been exceeded, as will be discussed in further detail below. Thus, if the number is either not in the fax-blocker database 305, or is in the database but not categorized as a fax-marketer, the fax-marketer detector 300 creates a record 400 of the calling number at block 525, or updates an existing record 400 of the calling number. As discussed earlier in light of the war-dialing techniques of FIG. 2(b), an update of an existing record 400 may include entry of another line item 405, as shown in FIG. 4. After the record 400 is updated or a new record 400 is created (block 525), control advances to block 550 where the fax-marketer detector routine is called. An example fax-marketer detector routine is discussed below in connection with FIG. 5(b).

Returning to block 520, if the originating number is a known fax-marketer, the fax-marketer detector 300 reviews the personalized list of the called subscriber at block 530 to determine if the fax transmission should be blocked or permitted (block 530). As discussed earlier, the subscriber's personalized list may be created and edited via the customer blocking service interface 330. Fax caller numbers not contained in the fax-blocker database 305 may be added by the subscriber for blocking. Conversely, numbers that exist in the database 305 may employ subscriber override rules to permit transmission of faxes from particular fax callers. The fax-marketer detector 300 reviews such subscriber personalized lists (e.g., the “allow list”) to either block additional fax caller numbers not contained within the database 305, or allow fax transmissions for fax caller numbers listed in the database 305 (block 530). If the call is to be blocked (block 530), control advances to block 535 where a message to block the fax call is returned to the IP/SN 130. One of ordinary skill in the art will appreciate that the message may be returned to an SCP and/or a feature/media server. If the call is to be permitted (block 530), control returns to block 500 to await the next call.

When a call is blocked (block 535), control advances to block 540. As discussed above, the subscriber may automatically employ the fax-back service and/or the announcement service by using the fax-back module 350 after blocking the fax transmission. When so employed, a standard or personalized fax-back message (created by the subscriber with the customer blocking service interface 330) is sent to the fax-back module 350 along with the number of the fax marketer (block 540). The fax-back module 350 then secures a line and transmits the subscriber's fax message indicating, for example, that future calls are not welcome and will be blocked immediately (block 545). Control then returns to block 500 to monitor for additional fax calls. If the fax-back service is not employed (block 540), control returns to block 500 without passing through block 545.

An example fax-marketer detection routine, which may be called at block 550, is shown in FIG. 5(b). In the example of FIG. 5(b) the pattern-trap 320 analyzes the incoming call, or series of calls, to determine if a war-dialing technique is immediately evident (block 555). As discussed in connection with FIG. 2(a), the pattern-trap 320 may identify a series of numerically consecutive destination numbers being called substantially simultaneously by one or more originating numbers potentially affiliated with the same entity as fax dialing behavior indicative of a fax-marketer. When such behaviors are identified by the pattern-trap 320 (block 555), the fax-marketer detector 300 updates the fax-blocker database 305 to identify the caller(s) as fax-marketer(s).

The pattern-trap 320 may be structured to detect a variety of war dialing techniques. As fax-marketers develop new war dialing techniques, the pattern-trap 320 may be updated to detect those techniques. This is particularly easy when the pattern-trap 320 is implemented by software.

If the originating caller is not exhibiting calling conduct immediately indicative of war-dialing (block 555), such as conduct illustrated in FIG. 2(a), the pattern-trap 320 may determine whether the originating caller's conduct is indicative of fax-marketing by retrieving (block 560) and evaluating the record(s) 400 associated with the originating number(s) in question (block 565). As discussed in connection with FIG. 2(b), if fax calling patterns are detected over a predetermined period of time, such as numerically consecutive fax calls dialed sequentially by one or more originating lines, control advances to block 580 and the originating line(s) originating the fax call is identified as a fax-marketer. Other patterns detected by the pattern-trap 320 may include, but are not limited to, detection of integer skipping (e.g., 555-1111, 555-1113, 555-1115, etc.), alternating sub-patterns (e.g., 555-1111, 555-1121, 555-1131, 555-1112, 555-1122, 555-1132, etc.), and fibonacci-type patterns (e.g., starting with a ‘seed’ number 555-1101, 555-1101, 555-1102, 555-1103, 555-1105, 555-1108, 555-1113, 555-1121, etc.).

Fax calling patterns may also be identified by the pattern-trap 320 in view of various thresholds, also shown in FIG. 2(b). In particular, originating numbers dialing beyond a first threshold (block 570), such as the “suspected threshold” 262 of FIG. 2(b), are allowed to complete the fax call at block 595, as long as the originating number(s) do not exceed a second threshold (block 575). However, originating numbers exceeding both the first and the second thresholds, such as the “confirmed threshold” 264 of FIG. 2(b) (block 575), are identified as fax-marketers (block 580).

Persons of ordinary skill in the art will appreciate that the first threshold (block 570) and the second threshold (block 575) may include a variety of other parameters. Predetermined thresholds may include, for example, a parameter counting the number of times a fax transmission is received, a parameter recording the dates and/or times that a fax transmission is received, a number of faxes to consecutive destination numbers, and/or a parameter reflecting the duration of each fax transmission received. The subscriber may set limits for each of these parameters (i.e., thresholds) in the customer blocking service interface 330. As an example, the subscriber may set a threshold of three fax transmissions within a duration spanning one week. Fax transmissions attempting to make a fourth call within the time period of one week will subsequently be identified as a fax-marketer at block 580.

Because the fax-marketer detector 300 always updates the record 400 of an originating caller at block 525, even if a fax-marketer eludes immediate detection of a war-dialing technique, the subsequent analysis of an originating calling pattern over a longer period of time, and/or monitoring for various threshold violations, preferably enables the fax-blocker 195 to eventually identify such fax-marketers. If fax-marketers are identified in such a manner, the fax-marketer detector 300 further determines whether the called party is a subscriber (block 585) and, if so, sends a message to the IP/SN 130 to block the call (block 590). On the other hand, if the called party is not a subscriber (block 585), a message is sent to the IP/SN 130 to complete the call (block 595). In either event, control returns to block 550 of FIG. 5(a). Thereafter, the fax-blocker 195 continues to monitor for additional calls (block 500).

Although for simplicity, the flowcharts of FIGS. 5(a)-5(b) have been described as a single program executed in a sequential fashion, persons of ordinary skill in the art will appreciate that multiple instances of one or more components of the program represented by FIGS. 5(a)-5(b) may be simultaneously executed to handle multiple calls in parallel. For example, a new instance (e.g., a thread) of the software may be spawned whenever a call is received (block 500) and the corresponding instance (e.g., thread) may be collapsed whenever control is returned to block 500.

Returning to FIG. 1, if the fax-blocker 195 is not currently operational, or if the fax-blocker 195 is operating on detecting fax-marketers not associated with a subscriber currently receiving a fax call, the subscriber will still realize benefits from prior fax-marketer detection efforts. The fax-marketer, using a fax-capable device, gains access to any telecommunications network through the SSP 120. The SSP 120, routes the call through the network and recognizes intelligent network calls and routes them pursuant to directions from the SCP 120. The STP 150 is a packet switch that shuttles messages between the SSP 120 and the SCP 140. The SCP 140 is referenced in view of the originating fax call for instructions on how to proceed. Because the SCP 140 contains data from the fax-blocker database 305, prior determinations of fax-marketers and their corresponding originating numbers are compared against the originating fax caller. The SCP 140 returns a block instruction if the originating fax caller number matches a fax-marketer number previously determined. Alternatively, if the originating fax number does not match a previously determined fax marketer, the SCP 140 returns an allow instruction, thereby permitting a destination fax-capable device to receive the fax. The SCP 140 may also interact with the IP/SN 130 to detect fax tones to determine if the call is a fax.

Because the SCP 140 has access to, or a copy of the fax-blocker database 305, the SCP 140 compares the originating number of the fax-capable device against the fax-blocker database 305. If the SCP 140 determines a match, the subscriber's personalized list is checked by the SCP 140 for specific fax numbers that the subscriber prefers to allow. If the personalized list does not include the originating number of the fax-capable device, then the call is blocked. On the other hand, if the personalized list includes the originating number of the fax-capable device, then the call is allowed. Similarly, if the SCP 140 finds no match in the fax-blocker database 305 in view of the originating number of the fax-capable device, then the call is allowed to proceed to the destination fax-capable device.

FIG. 6 is a block diagram of an example computer 600 capable of implementing the apparatus and methods disclosed herein. The computer 600 can be, for example, a server, a personal computer, an IP/SN, an SCP, an STP, or any other type of computing device.

The system 600 of the instant example includes a processor 610 such as a general purpose programmable processor. The processor 610 includes a local memory 611, and executes coded instructions 613 present in the local memory 611 and/or in another memory device. The processor 610 may execute, among other things, the example machine readable instructions illustrated in FIGS. 5(a) and 5(b). The processor 610 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 610 is in communication with a main memory including a volatile memory 612 and a non-volatile memory 614 via a bus 616. The volatile memory 612 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 614 may be implemented by flash memory and/or any other desired type of memory device. Access to the main memory 612, 614 is typically controlled by a memory controller (not shown) in a conventional manner.

The computer 600 also includes a conventional interface circuit 618. The interface circuit 618 may be implemented by any type of well known interface standard, such as an Ethernet interface, a universal serial bus (USB), and/or a third generation input/output (3GIO) interface.

One or more input devices 620 are connected to the interface circuit 618. The input device(s) 620 permit a user to enter data and commands into the processor 610. The input device(s) can be implemented by, for example, a keyboard, a mouse, a touchscreen, a track-pad, a trackball, isopoint and/or a voice recognition system.

One or more output devices 622 are also connected to the interface circuit 618. The output devices 622 can be implemented, for example, by display devices (e.g., a liquid crystal display, a cathode ray tube display (CRT), a printer and/or speakers). The interface circuit 618, thus, typically includes a graphics driver card.

The interface circuit 618 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 600 also includes one or more mass storage devices 626 for storing software and data. Examples of such mass storage devices 626 include floppy disk drives, hard drive disks, compact disk drives and digital versatile disk (DVD) drives. The mass storage device 626 may implement the fax-blocker database 305.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to block fax calls comprising:
detecting a fax call associated with a calling number;
blocking the fax call if the calling number is associated with a caller to be blocked identified in a database; and
attempting to identify a presence of a war-dialing technique.

2. A method as defined in claim 1 further comprising blocking the fax call if the presence of a war-dialing technique is identified and the fax call is sent to a subscriber, and permitting the fax call if the presence of a war-dialing technique is identified and the fax call is sent to a non-subscriber.

3. A method as defined in claim 1 wherein attempting to identify the presence of the war-dialing technique comprises evaluating destination numbers called from the calling number for at least one predetermined pattern characteristic of war-dialing.

4. A method as defined in claim 3 wherein the at least one predetermined pattern comprises at least one of: (a) a plurality of numerically consecutive destination numbers dialed simultaneously and/or, (b) a plurality of numerically consecutive destination numbers dialed sequentially.

5. A method as defined in claim 4 wherein adjacent numbers in the plurality of numerically consecutive destination numbers are each separated by a multiple.

6. A method as defined in claim 1 wherein detecting the fax call comprises monitoring for fax tones with at least one of an IP/SN device and a fax-tone detector.

7. A method as defined in claim 1 further comprising querying a subscriber list for calling numbers to be identified by a subscriber.

8. A method as defined in claim 7 wherein the calling numbers identified by the subscriber are designated to be blocked or designated to not be blocked.

9. A method as defined in claim 1 further comprising executing at least one user defined fax call routing rule, the fax call routing rule comprising at least one of allowing fax calls for an identified calling number, blocking fax calls for an identified calling number, and blocking fax calls exceeding one or more predetermined calling thresholds.

10. A method as defined in claim 1 further comprising automatically sending a return fax to the calling number if the fax call is blocked.

11. A method as defined in claim 1 wherein if the presence of a war-dialing technique is detected, the calling number is identified in the database as associated with the caller to be blocked.

12. An article of manufacture storing machine readable instructions which, when executed, cause a machine to:
detect fax calls associated with a calling number;
block the fax call if the calling number is associated with a caller to be blocked identified in a database; and
attempt to identify a presence of war-dialing technique.

13. An article of manufacture as defined in claim 12 wherein the machine readable instructions further cause the machine to block the fax call if the presence of a war-dialing technique is identified and the fax call is sent to a subscriber, and to permit the fax call if the presence of a war-dialing technique is identified and the fax call is sent to a non-subscriber.

14. An article of manufacture as defined in claim 12 wherein the machine readable instructions attempt to identify the presence of the war-dialing technique by evaluating destination numbers called from the calling number for at least one predetermined pattern characteristic of war-dialing.

15. An article of manufacture as defined in claim 14 wherein the at least one predetermined pattern comprises: (a) a plurality of numerically consecutive destination numbers dialed simultaneously and/or, (b) a plurality of numerically consecutive destination numbers dialed sequentially.

16. An article of manufacture as defined in claim 12 wherein the machine readable instructions cause the machine to automatically send a return fax to the calling number if the fax is blocked.

17. An article of manufacture as defined in claim 12 wherein if the presence of a war-dialing technique is identified, the machine readable instructions cause the machine to identify the calling number in the database as associated with the caller to be blocked.

18. An apparatus to block fax calls comprising:
a pattern-trap to identify originating phone numbers exhibiting a calling pattern indicative of fax-marketing;
a fax-originator database to store identities of callers to be blocked; and
a fax-originator detector in communication with the fax-originator database to determine if a fax call should be blocked.

19. An apparatus as defined in claim 18 further comprising a fax-tone detector to detect fax calls.

20. An apparatus as defined in claim 18 further comprising a customer blocking service interface to facilitate subscriber configuration of fax call blocking.

21. An apparatus as defined in claim 18 wherein the calling pattern comprises at least one of: (a) a plurality of numerically consecutive destination numbers dialed simultaneously and/or, (b) a plurality of numerically consecutive destination numbers dialed sequentially.

22. An apparatus as defined in claim 21 wherein the numerically consecutive destination numbers are separated by a multiple.

23. An apparatus as defined in claim 18 wherein the fax-originator database comprises a fax caller record.

24. An apparatus as defined in claim 18 further comprising a fax-back module to fax a return fax message to the callers to be blocked associated with a blocked call.

25. A method to identify callers to be blocked comprising:
identifying a plurality of fax calls from an originating number;
evaluating the calls to determine if they fit a war-dialing pattern; and
identifying the originating number as being associated with the caller to be blocked if the calls fit the war-dialing pattern.

26. A method as defined in claim 25 wherein the war-dialing pattern comprises at least one of: (a) a plurality of numerically consecutive destination numbers dialed simultaneously and/or, (b) a plurality of numerically consecutive destination numbers dialed sequentially.

27. A method as defined in claim 26 wherein adjacent numbers in the plurality of numerically consecutive destination numbers are each separated by a multiple.

28. A method as defined in claim 25 wherein the war-dialing pattern comprises placing a predetermined number of fax calls in a predetermined time period.

29. A method as defined in claim 25 wherein the war-dialing pattern comprises placing a predetermined number of fax calls to sequential numbers.

30. A method as defined in claim 25 wherein identifying the originating number as being associated with the caller to be blocked comprises adding the originating numbers to a fax-originator database.
